(19) United States
(12) Patent Application Publication
(10) Pub. No.: US 2011/0004348 A1
(43) Pub. Date: Jan. 6, 2011

(54) ARRANGEMENT FOR TRANSMITTING DATA AND/OR SIGNALS IN A TRANSMISSION

(75) Inventors: Karl-Hermann Ketteler, Markdorf (DE); Juergen Kett, Friedrichshafen (DE); Andreas Fuessl, Kressbronn (DE); Notker Amann, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/920,324

(22) PCT Filed: Feb. 6, 2009
(86) PCT No.: PCT/EP09/51390

§ 371 Date: Aug. 31, 2010

(30) Foreign Application Priority Data
Mar. 13, 2008 (DE) 10 2008 000 639.4

(51) Int. Cl. G05B 15/02

(52) U.S. Cl. 700/275

(57) ABSTRACT

An arrangement for transmitting data and/or signals between a transmission control device (1) and a plurality of actuator control devices (2A, 2B, 2C) for the local control of actuation movement of actuating shifting units. The transmission control device (1) and the actuator control devices (2A, 2B, 2C) are disposed such that they are movable relative to one another. At least one wireless communication transmission unit is provided, at least in sections, between the transmission control device (1) and the actuator control devices (2A, 2B, 2C).

This application is a National Stage completion of PCT/EP2009/051390 filed Feb. 6, 2009, which claims priority from German patent application serial no. 10 2008 000 639.4 filed Mar. 13, 2008.

### FIELD OF THE INVENTION

The present invention relates to an arrangement for transmitting data and/or signals between a transmission control device and a plurality of actuator control devices.

### BACKGROUND OF THE INVENTION

In the case of known automated transmissions and automatic transmissions it is necessary for control and feedback signals, and application data to be exchanged between transmission actuators which actuate the shifting units of the transmission, within the transmission with a control device that is typically outside of the transmission. The actuator systems of the automated transmission and automatic transmission are designed such that the actuating unit for the actuation movements of shifting, selecting, and coupling at the shifting units, are typically fixed to the transmission housing, and therefore not to movable parts. The actual actuation movement, which in most cases changes the position of rotating parts of the shifting unit, is implemented with the aid of mechanical, hydraulic or pneumatic transfer elements. The control and feedback of the individual actuators or actuating units is performed centrally by a transmission control device thereby resulting in a concentrated feedback control system.

If the aim is to reduce the extent of the mechanical, hydraulic or pneumatic transmission path due to design freedoms and reductions in installation space, the actuators and the actuating units must be moved to the location of the actual actuation movement of the shifting units. This means that the formerly stationary actuators must be placed on moving parts. These moving parts are parts of the transmission that are involved in the transfer of torque and therefore must also be accelerated or braked. The actuator, for example, can also be provided on an interior component of the transmission, for instance, a transmission shaft, thereby eliminating the concentrated feedback control system since each actuator requires a separate control device for its positioning tasks. This results in a distributed feedback control system. Since the control and feedback signals and the application data must be exchanged between the control devices, control devices that likewise rotate are also provided. Communication can not be carried out using wired communication systems in this arrangement possibility.

### SUMMARY OF THE INVENTION

Accordingly, the objective of the present invention is to propose an arrangement for transmitting data and/or signals of the initially described type, which realizes communication between the actuator control devices that are movable relative to each other, and the transmission control device in the simplest manner.

Accordingly, an arrangement for transmitting data and/or signals between a transmission control device and a plurality of actuator control devices for the local control of actuation movements for actuating the shifting units is proposed, wherein the transmission control device and the actuator control devices are disposed such that they move relative to each other. According to the invention, at least one communication transmission unit, which is preferably wireless or the like, can be provided between the transmission control device and the actuator control devices.

In this manner, the problem regarding the communication between moving and non-moving control devices, or the like, can be solved in that the various control devices are coupled together partially, or in sections via wires, and are coupled together partially, or in sections, wirelessly for data and/or signal transmission. The proposed communication transmission unit can transmit the required data and signals or the like in any manner to control the actuator control devices. Capacitance, inductive, optical and/or radio-based units can be used for this purpose. The communication should be designed for safety-critical applications, and should optionally provide redundant transmission paths.

Accordingly one possible variant embodiment of the present invention can provide that the communication transmission unit comprises at least one communication interface, or the like on the transmission control side, and at least one communication interface on the actuator control side which communicate wirelessly with each other via a capacitive, inductive, optical or similar transmission path. Preferably at least one stationary, external communication interface and one movable communication interface disposed internally serve as the gateway for the transmission path located in the system. Other embodiments of the communication transmission unit are also possible.

If, for example, the transmission control device is fastened on the outside of the transmission, for instance, to the housing, it can be provided that the communication interface, which is preferably likewise fastened to the housing, is connected via at least one wired data bus or the like to the transmission control device. Any possible type of connection can be used as a data bus.

In order to connect the actuator control devices disposed, e.g., in or on a shaft in the case of the transmission, it can be provided according to the following embodiment that the communication interface on the actuator control side is connected to the actuator control devices via a wired data bus for example. Here too, any possible type of connection can be used as a data bus.

According to an alternative embodiment of the invention, the communication transmission unit can comprise, for example, a plurality of communication interfaces. Each communication interface can be assigned, for example, to one actuator control device. In this embodiment, each communication interface can be connected to the assigned actuator control device via a separate wired data bus or the like. Here again, any other type of connection can be used.

The proposed arrangement can be used in any arbitrary transmission to solve the problem regarding communication between moving components and non-moving components with respect to data and signal transmission between the different control devices.

### BRIEF DESCRIPTION OF THE DRAWINGS

The present invention is described in greater detail in the following with reference to the drawings. They show:

FIG. 1 a schematic view of a first possible variant embodiment of an arrangement according to the invention; and

FIG. 2 a schematic view of a second possible variant embodiment of the arrangement

### DETAILED DESCRIPTION OF THE PREFERRED EMBODIMENTS

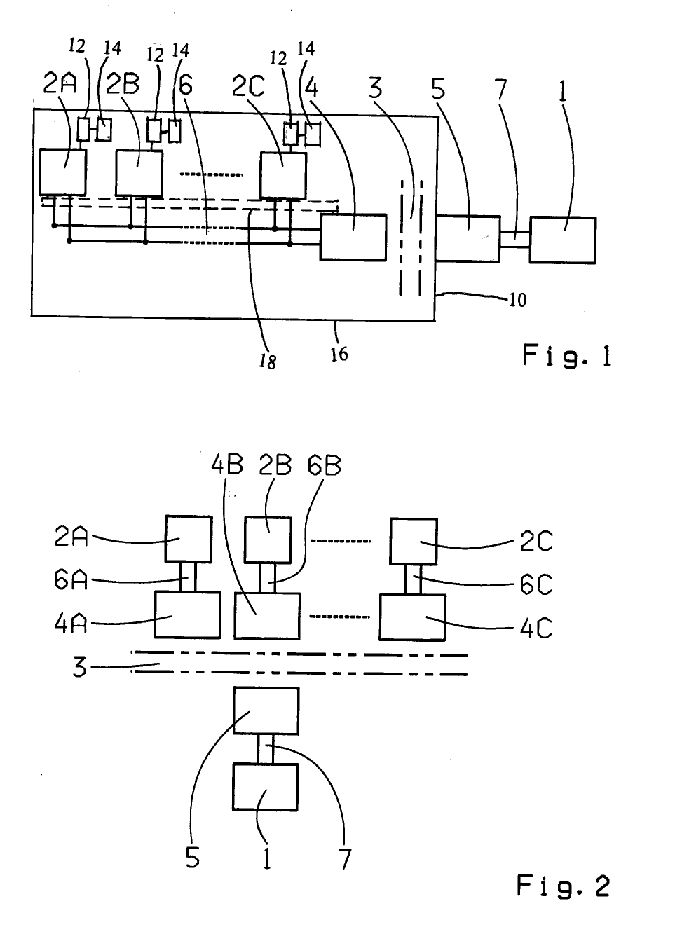

FIGS. 1 and 2 each show a possible variant embodiment of an arrangement according to the invention for transmitting data and/or signals between a transmission control device 1 and a plurality of actuator control devices 2A, 2B, 2C in a vehicle transmission 10.

The distributed transmission feedback control system comprises of a number n of actuator control devices 2A, 2B, 2C. These actuator control devices 2A, 2B, 2C serve as local control of the actuating units 12, which move the respectively assigned shift units 14 between the shift positions. The transmission control device 1 generates the control signals required for the actuator control devices 2A, 2B, 2C, and receives feedback from them about the state of the actuators. Depending on the variant embodiment, one or more communication interfaces 4, 4A, 4B, 4C that may be movable in the interior of the transmission, and one external communication interface 5 that is possibly fixed to the housing 16 are provided as a gateway for the transmission path 3 of a communication transmission unit located in the system. According to the invention, a capacitive, inductive, optical, or similar transmission type is provided as the transmission path 3 between the movable communication interface 4, 4A, 4B, 4C and the communication interface 5 that is fixed to the housing.

FIG. 1 shows a first variant embodiment of the arrangement. According to this approach, only one movable communication interface 4 disposed e.g. on or in a transmission shaft 18, is provided. The various actuator control devices 2A, 2B, 2C, which are likewise disposed, for example, on or in a transmission shaft, are therefore connected to the communication interface 4 via a common data bus 6 for exchanging data and/or signals. The control and feedback signals for all actuator control devices 2A, 2B, 2C are written to and read from this bus. This entirety of signals is transmitted via the global communication interface 4 from inside the transmission via the transmission path 3 to the external communication interface 5. Communication is therefore established between the transmission control device 1 and the actuator control devices 2A, 2B, 2C. A wired data bus 7 for transmitting data and/or signals is provided between the communication interface 5 and the control device 1. For transmitting signals, one transmission protocol is necessary for the section of wired communication, and a further transmission protocol is required for the wireless transmission path 3 between the two communication interfaces 4 and 5.

FIG. 2 shows a second possible variant embodiment of the arrangement according to the invention. In the second variant embodiment, each actuator control device 2A, 2B, 2C has its own internal communication interface 4A, 4B, 4C. Therefore, the wired data bus 6 between the actuator control devices 2A, 2B, 2C is omitted. The information of the individual actuator control devices 2A, 2B, 2C is transmitted directly via the particular assigned communication interface 4A, 4B, 4C and the wireless communication path 3. For this purpose, a wired data bus 6A, 6B, 6C is provided between each actuator control device 2A, 2B, 2C and each communication interface 4A, 4B, 4C. Here, data can be exchanged between the actuator control devices 2A, 2B, 2C in exactly the same manner as between the actuator control devices 2A, 2B, 2C and the external communication interface 5, and therefore, with the transmission control device 1, wherein a suitable transmission protocol is used for the transmission between the internal, movable communication interface 4A, 4B, 4C disposed in the transmission and the fixed communication interface 5 disposed, for example, on the transmission housing, via the wireless transmission path 3. The wired data bus 7 for transmitting data and/or signals is provided again between the communication interface 5 and the control device 1.

Independent of the respective variant embodiment, with the arrangement according to the invention, the communication problem of the known arrangement is solved mainly in that the different control devices can be coupled together for data and/or signal transmission to some extent via wires and to some extent wirelessly.

### REFERENCE CHARACTERS

1 transmission control device
2A, 2B, 2C actuator control device
3 transmission path
4, 4A, 4B, 4C communication interface
5 communication interface
6, 6A, 6B, 6C data bus
7 data bus

1-5. (canceled)

6. An arrangement for transmitting at least one of data and signals between a transmission control device (1) and a plurality of actuator control devices (2A, 2B, 2C) for local control of actuation movement for actuating shifting units, the transmission control device (1) and the actuator control devices (2A, 2B, 2C) being disposed such that the transmission control device (1) and the actuator control devices (2A, 2B, 2C) are movable relative to one another,
wherein at least one wireless communication transmission unit is provided between the transmission control device (1) and the actuator control devices (2A, 2B, 2C).

7. The arrangement according to claim 6, wherein the communication transmission unit comprises at least one communication interface (5), on the transmission control device side, and at least one communication interface (4, 4A, 4B, 4C), on the actuator control device side, which communicate wirelessly with one other via at least one of a capacitive, an inductive, an optical and a radio-based transmission path (3).

8. The arrangement according to claim 7, wherein the transmission control device (1), fastened to a housing, is connected to the communication interface (5), fastened to the housing, via at least one wired data bus (7).

9. The arrangement according to claim 6, wherein the communication interface (4) on the actuator control device side is connected, via a wired data bus (6), to a plurality of actuator control devices (2A, 2B, 2C).

10. The arrangement according to claim 6, wherein a plurality of communication interfaces (4A, 4B, 4C), on an actuator control device side, are provided which are each connected, via a wired data bus (6A, 6B, 6C), to an assigned actuator control device (2A, 2B, 2C).

11. A transmission control and feedback system for transmitting signals between a transmission control device (1) and at least one actuator control device (2A, 2B, 2C) for controlling actuation of shifting units (14) of a transmission (10), the control and feedback system comprising:
a fixed communication interface (5) being fixed to a housing (16) of the transmission (10) and connected, via a wired first data bus (7), to the transmission control device (1) for transmitting the signals therebetween;
at least one movable communication interface (4) being coupled to a transmission shaft (18) and communicating, via at least one second data bus (6), with the at least one actuator control device (2A, 2B, 2C) for transmitting the signals therebetween, and
the at least one actuator control device (2A, 2B, 2C) being coupled to the transmission shaft (18) and a respective actuating unit (12) which actuates one of the shifting units (14); and
at least one wireless transmission path (3) being formed between the fixed communication interface (5) and the at least one movable communication interface (4) for transmitting the signals therebetween.

12. The arrangement according to claim 11, wherein the at least one wireless transmission path (3) is at least one of a capacitive, an inductive, an optical and a radio-based transmission path.
